(19) United States
(12) Patent Application Publication
(10) Pub. No.: US 2019/0161643 A1
(43) Pub. Date: May 30, 2019

(54) Combination Wood Stain and Sealant and Method of Application

(71) Applicant: Promxx, LLC, d/b/a Waterbear Pro LLC, Weatherford, TX (US)

(72) Inventor: Russell Leon Haskell, Weatherford, TX (US)

(73) Assignee: Promxx, LLC, d/b/a Waterbear Pro LLC, Weatherford, TX (US)

(21) Appl. No.: 16/202,857

(22) Filed: Nov. 28, 2018

Related U.S. Application Data
(60) Provisional application No. 62/592,113, filed on Nov. 29, 2017.

(51) Int. Cl. C09D 191/06; C09D 15/00; C09D 7/20

(52) U.S. Cl. CPC C09D 191/06; C09D 7/20; C09D 15/00

(57) ABSTRACT

A method is shown for treating a wood substrate which both stains and simultaneously seals. First a sealant composition is formulated by combining a commercially and industrially sold stain with a micro-crystalline pre-mixture, the micro-crystalline pre-mixture being comprised of a micro-crystalline wax in an organic solvent blend. Next, the wood substrate is contacted with the sealant composition and the solvent blend is allowed to flash away, leaving a substantially solvent free micro-crystalline wax residue barrier. The solvent blend can be a mixture of hexane and xylene but is not limited to these two particular solvents.

### BACKGROUND OF THE INVENTION

### 1. Field of the Invention

The present invention relates to compositions for use in staining and sealing wood, as well as to a method for applying such a composition to a wood substrate, and more particularly to a formula combining commercially and industrially market available stains with a special micro-crystalline pre-mixture.

### 2. Description of the Prior Art

Finishes which are useful on porous substrates such as wood, concrete, cement, brick and the like typically fall into two broad classifications: surface coatings and penetrating finishes. In most cases, surface coatings are characterized by having a very high molecular weight, by being highly crosslinked, and characteristically form a continuous film over the substrate. Varnishes and polyurethane clearcoats are typically classified as surface coatings.

Penetrating finishes, in addition to protecting the substrate, typically change a substrate's color, yet retain the natural textural appearance of the substrate. Penetrating pigmented stains, non-pigmented wood preservatives, and water sealants are typical examples of penetrating finishes. One key attribute of penetrating finishes is that they are designed so as not to form an appreciable surface film or coating on the wood/substrate. They are typically low in molecular weight and very small particle size. They are fairly durable and are suited for textured, exposed surfaces such as siding, decks, steps and the like. They can contain water repellants. The ability to penetrate into the surface without leaving a significant or appreciable film on the surface can help to eliminate the peeling and cracking that varnishes and other similar surface coatings experience.

Penetrating finishes can be further subdivided as clear systems or colored systems. The clear systems typically contain a water repellant. When applied to a wood or porous substrate, these compositions serve to protect the substrate from moisture. In addition to their protective characteristics, the colored systems are designed to change the color of the wood or porous surface without hiding the grain or texture of the substrate.

In the past, commercial architectural penetrating stains and water sealants have generally been formulated from oil-based compositions. Many commercially available wood stains still utilize pure linseed oil. Oil-based compositions are relatively inexpensive and provide good spreading characteristics. However, such stains typically lack good abrasion resistance and good drying characteristics.

Most commercial stains claim to have waterproofing characteristics. However many are simply using the “Law of Displacement”, i.e., that two objects can't occupy the same space at the same time. In other words, if one saturates a piece of wood with an oil based stain and allows it to dry, water will be temporally repelled. This effect is short lived, however, due to the fact that the oil base in these stains will dry and begin to crack due to heat, exposure and UV rays from the sun. The end result is a stain and sealant that no longer can repel water as originally intended.

It is therefore an object of this invention to overcome many of the shortcomings of the prior art by furnishing a non-penetrating wood finish which has many of the desirable characteristics of the penetrating finishes described above by using a liquid sealant micro-crystalline pre-mixture combined with commercially or industrially market available wood stains, such as traditional oil based and other commercial stains.

It is also an object of the present invention to substantially reduce the amount of stain required for a given job, the time required for application, and the cure time required, while also increasing the square foot coverage area per gallon. The result is a dramatic reduction in the overall cost per gallon for the job being performed.

### SUMMARY OF THE INVENTION

The foregoing objects of the invention are met through a formula which combines commercially and industrially market available stains with a special micro-crystalline pre-mixture, to be described in greater detail hereafter. In one embodiment, the micro-crystalline pre-mixture is comprised of a micro-crystalline wax in an organic solvent blend. The commercially and industrially market available stain is added to the chemical pre-mixture. A wood substrate is then contacted with the stain/sealant composition and the solvent blend is allowed to flash away, leaving a substantially solvent free micro-crystalline wax residue barrier on the wood substrate.

The combination stain and sealant can be applied in any of a number of convenient ways, as by being rolled or brushed onto the wood substrate or by being sprayed onto the wood substrate.

The solvent blend can vary depending upon the particular end application. One acceptable blend is a mixture of hexane and xylene. One particularly preferred sealant and stain composition comprises an organic solvent blend which is approximately 83.25% hexane and 3% xylene blended with 10% micro-crystalline wax and 3.75% commercially and industrially market available stain. One acceptable micro-crystalline wax has a weight in the range from about 570-750 g/mole.

A particularly preferred method for treating a wood substrate according to the teachings of the present invention comprises the steps of:

formulating a liquid stain/sealant composition by combining a commercially and industrially market available stain with a micro-crystalline pre-mixture, the micro-crystalline pre-mixture being comprised of a micro-crystalline wax in an organic solvent blend;

wherein the stain/sealant composition is prepared by adding the micro-crystalline wax to a solvent blend containing hexane and xylene, the micro-crystalline wax being heated to its melting point and then added to the solvent blend at ambient temperature with frequent stirring until the micro-crystalline wax is completely dispersed throughout the solvent blend, thereby forming the chemical pre-mixture;

the chemical premixture is then containerized and sealed;

wherein once the pre-mixture is prepared, the commercial stain is blended with the pre-mixture to form the liquid stain/sealant;

thereafter, contacting the wood substrate with the stain/sealant composition and allowing the solvent blend to flash away after initial curing, leaving an essentially non-toxic and substantially solvent free micro-crystalline wax residue barrier on the wood substrate.

Additional objects, features and advantages will be apparent from the written description which follows.

### DETAILED DESCRIPTION OF THE INVENTION

The invention described herein and the various features and advantageous details thereof are explained more fully with reference to the non-limiting examples which are detailed in the following description. Descriptions of well-known components and processes and manufacturing techniques are omitted so as to not unnecessarily obscure the workings of the invention. The examples used herein are intended merely to facilitate an understanding of ways in which the invention herein may be practiced and to further enable those of skill in the art to practice the invention. Accordingly, the examples should not be construed as limiting the scope of the claimed invention.

The organic phase of the invention includes as one ingredient a hydrophobic component. The hydrophobic component is preferably a strong hydrophobe. Exemplary strong hydrophobes include waxes, such as petroleum waxes, natural waxes, synthetic waxes, or a combination of these. Exemplary petroleum waxes include slack wax or microcrystalline wax. Exemplary natural waxes include bees' wax or carnauba wax. Exemplary synthetic waxes include polyethylene wax or oxidized polyethylene wax. Preferred waxes have a melting point in the range from about 30-100° C., more preferably in the range from about 40 to 90° C. The most preferred wax is a microcrystalline wax having a melting point in the range from about 60° C. to about 87.78° C. The wax component of the current invention includes those that provide good water repellency to wood and wood products. Exemplary concentrations of the hydrophobic component are 2 to 30 weight %, more preferably about 5 to 15 weight %, most preferably about 10 weight %, based on the total weight of the stain/sealant formulation.

Microcrystalline waxes are a type of wax that can be produced, for example, by de-oiling petrolatum, as part of the petroleum refining process. In contrast to the more familiar paraffin wax which contains mostly unbranched alkanes, microcrystalline wax contains a higher percentage of isoparaffinic (branched) hydrocarbons and naphthenic hydrocarbons. It is characterized by the fineness of its crystals in contrast to the larger crystal of paraffin wax. It consists of high molecular weight saturated aliphatic hydrocarbons. It is generally darker, more viscous, denser, tackier and more elastic than paraffin waxes, and has a higher molecular weight and melting point. However, the microcrystalline wax can be further processed to achieve greater purity levels at the refinery level. The elastic and adhesive characteristics of microcrystalline waxes are related to the non-straight chain components which they contain. Typical microcrystalline wax crystal structure is small and thin, making them more flexible than paraffin wax. They are commonly used in cosmetic formulations, as well as a food ingredient.

Microcrystalline waxes when produced by wax refiners are typically produced to meet a number of ASTM specifications. These include congeal point (ASTM D938), needle penetration (D1321), color (ASTM D6045), and viscosity (ASTM D445). Microcrystalline waxes can generally be put into two categories: “laminating” grades and “hardening” grades. The laminating grades typically have a melt point of 140-175° F. (60-80° C.) and needle penetration of 25 or above. The hardening grades will range from about 175-200° F. (80-93° C.), and have a needle penetration of 25 or below. Color in both grades can range from brown to white, depending on the degree of processing done at the refinery level.

In the method of the present invention, a special micro-crystalline wax pre-mixture is used in combination with a commercially available oil based stain, with the micro-crystalline wax acting as a carrier of the stain. The micro-crystalline wax traps the stain, not allowing it to be absorbed into the wood as with the prior art compositions. The direct result is a wood surface which is stained with at least 90% less stain that would be ordinarily required for the project since the stain is not being absorbed into the wood substrate as described with respect to the prior art. The solvent mixture used in the special chemical pre-mixture of the invention is allowed to flash away after the initial curing, leaving an essentially non-toxic and substantially solvent free micro-crystalline wax residue barrier on the wood substrate. By “substantially solvent free” is meant that there is no chemical odor after the initial curing step. The thickness of the wax residue barrier left on the wood substrate after curing will generally be in the range from about 0.5 mm to about 1.5 mm, depending upon the application technique.

In the preferred embodiment, the present invention is created by adding a micro-crystalline wax to a solvent mixture containing hexane (CAS# 110-54-3) and xylene (CAS# 1330-20-7). The micro crystalline wax is heated to its melting point and then added to the solvent blend to form the special pre-mixture at ambient temperature stirring frequently and consistently until the micro-crystalline wax is completely dispersed throughout the solvent blend, thereby forming the chemical pre-mixture. In one preferred embodiment the chemical pre-mixture is 10% micro-crystalline wax with a weight of 570-750 g/mole. The micro-crystalline wax used in the mixture of the present invention can vary in molecular weight however micro-crystalline wax with a high tensile strength is recommended for its ability to adhere without losing its bonding affinity to the item being sealed.

Once the chemical pre-mixture is prepared, the commercial and industrially market available stain is blended. There are any number of commercially available stains on the market. Any of a number of commercially available oil based stains will be acceptable for purposes of the present invention. For example, one commercially available wood stain is sold under the tradename Ready Seal® by Ready Seal, Inc., of Lewisville, Tex. Its Material Data Safety Sheet lists the following compositional make-up:

### SECTION 3

### Composition/Information on Ingredients

| | | |
|---|---|---|
| MATERIAL | CAS# | WT % |

Mineral Oil Containing:

| | | |
|---|---|---|
| Distillates, solvent refined | 64741-89-5 | 0-100 |
| Light | | |
| Distillates, solvent refined | 64741-88-4 | 0-100 |
| Heavy | | |
| Distillates, severely hydrotreated | 64742-54-7 | 0-100 |
| Heavy | | |

One particularly preferred stain/sealant formulation of the invention comprises a liquid blend (solution) of approximately 83.25% hexane, 3% xylene, 10% micro-crystalline wax, and 3.75% commercial stain, all percentages being percentages by weight based on the total weight of the stain/sealant formulation.

The combination of distillates used is selected to have a lighter specific gravity than the micro-crystalline wax and the stain and performs the function of keeping the micro-crystalline wax from re-solidifying into a solid piece. This allows for even disbursement of the micro-crystalline wax onto the wood substrate. The result is a consistent, even application of the stain/sealant combination to the wood substrate in one step, all the while utilizing far less commercially and industrially market available stain.

The most preferred method for treating a wood substrate according to the teachings of the present invention comprises at least the following method steps:

formulating a liquid stain/sealant composition by combining a commercially and industrially sold stain with a micro-crystalline pre-mixture, the micro-crystalline pre-mixture being comprised of a micro-crystalline wax in an organic solvent blend;

wherein the stain/sealant composition is prepared by adding the micro-crystalline wax to a solvent blend containing hexane and xylene, the micro-crystalline wax being heated to its melting point and then added to the solvent blend at ambient temperature with frequent stirring until the micro-crystalline wax is completely dispersed throughout the solvent blend, thereby forming the chemical pre-mixture;

wherein once the pre-mixture is prepared, the commercial stain is blended with the pre-mixture to form the liquid stain/sealant;

thereafter, contacting the wood substrate with the stain/sealant composition and allowing the solvent blend to flash away after initial curing, leaving a non-toxic and substantially solvent free micro-crystalline wax residue on the wood substrate.

An invention has been provided with several advantages. There are many uses for the present invention both commercial and industrial. The present invention may serve as a protective stain/sealer composition which acts as a two in one application for a wide variety of items including but not limited to wood fences, wood decks, outdoor furniture and wood siding on buildings.

Traditionally, in the area of wood fence and deck protection, the industry has followed one general process.
1. Prepping the wood substrate surface by removing all loose shavings and debris.
2. Staining the surface to the desired color.
3. The surface is then allowed to thoroughly dry and cure. This can take up to two days.
4. The newly stained surface is then sealed with a commercial sealer. This too may take up to two days to cure.

There are a number of disadvantages that are inherent in the prior art process, as briefly described above. For one thing, the process in its totality is lengthy and expensive. Let's examine a typical example:

By way of example, the following pricing per gallon was obtained from Home Depot™ and Lowes™ and represents current averages:

Assume there is 6000 sq. ft. of fence to be prepped, stained and sealed:

| | | |
|---|---|---|
| 1. Pretreatment of fence: | 30 gal/200/sqft/gal | @$15.00/gal |
| 2. Stain fence: | 30 gal/200/sqft/gal | @$15.00/gal |
| 3. Seal fence: | 30 gal/200/sqft/gal | @$15.00/gal |
| 4. Time to complete the project: | 3 days | |

In this example, the total cost for materials is $2,550.00 and doesn't account for any labor cost the might be included. This process, although standard in the industry, is very time consuming and wasteful. Also, approximately 95% of the stain purchased for the prior illustration was wasted through the absorption and the porosity of the wood surface being stained.

In one demonstration a 6,600 sqft fence was completely stained, waterproofed, and sealed with one coat of the micro/stain combination. The amount of stain required was less than one gallon total. The amount of micro crystalline wax and pre mixture was 20 gallons. This is roughly 315 sqft/gallon coverage. Cure time was 15 minutes.

A further advantage of the process of the invention is that the stain/sealant composition can be applied using ordinary brush or spray technology. For example, it can be applied by a low pressure sprayer, airless pressure sprayer or roller.

It should also be noted that the indirect consequence of using the special micro-crystalline pre-mixture as the carrier is that the process achieves the following further advantages:
1. A highly hydrophobic protective barrier.
2. UV protection, thereby slowing of the natural graying of wood.
3. A fast cure time. Minutes versus days.

While the invention has been shown in several of its forms, it is not thus limited but is susceptible to various changes and modifications without departing from the spirit thereof, as described in the claims which follow.

What is claimed is:

1. A method for treating a wood substrate comprising the steps of:
formulating a sealant composition by combining a commercially and industrially sold stain with a micro-crystalline pre-mixture, the micro-crystalline pre-mixture being comprised of a micro-crystalline wax in an organic solvent blend;
contacting the wood substrate with the sealant composition and allowing the solvent blend to flash away, leaving a substantially solvent free micro-crystalline wax residue barrier.

2. The method of claim 1, wherein the sealant composition is sprayed onto the wood substrate.

3. The method of claim 1, wherein the sealant composition is brushed onto the wood substrate.

4. The method of claim 1, wherein the sealant composition is rolled on.

5. The method of Claim I, wherein the organic solvent blend is a blend of hexane and xylene.

6. The method of claim 5, wherein the organic solvent blend is approximately 83.25% hexane, 3% xylene, 10% micro-crystalline wax and 3.75% commercial stain.

7. The method of claim 1, wherein the preferred micro-crystalline wax has a weight of about 570-750 g/mole.

8. A method for treating a wood substrate comprising the steps of:
formulating a sealant composition by combining a commercially and industrially sold stain with a micro-crystalline chemical pre-mixture, the micro-crystalline pre-mixture being comprised of a micro-crystalline wax in an organic solvent blend;
wherein the sealant composition is prepared by adding the micro-crystalline wax to a solvent blend containing hexane and xylene, the micro-crystalline wax being heated to its melting point and then added to the solvent blend at ambient temperature with frequent stirring until the micro-crystalline wax is completely dispersed throughout the solvent blend, thereby forming the chemical pre-mixture;
wherein once the pre-mixture is prepared, the commercial stain is blended with the pre-mixture;
thereafter, contacting the wood substrate with the sealant composition and allowing the solvent blend to flash away after initial curing, leaving a non-toxic and substantially solvent free micro-crystalline wax residue barrier.

9. The method of claim 8, wherein the sealant composition is sprayed onto the wood substrate.

10. The method of claim 8, wherein the sealant composition is brushed onto the wood substrate.

11. The method of claim 8, wherein the sealant composition is rolled on.

12. The method of claim 8, wherein the organic solvent blend is approximately 83.25% hexane, 3% xylene, 10% micro-crystalline wax and 3.75% commercial stain.

13. The method of claim 12, wherein the preferred micro-crystalline wax has a weight of about 570-750 g/mole.

14. A combination wood stain and sealant composition for a wood substrate, the composition comprising:
a combined initially liquid composition which is formulated by combining a commercially and industrially sold wood stain with a micro-crystalline wax pre-mixture, the micro-crystalline wax pre-mixture being comprised of a micro-crystalline wax in an organic solvent blend;
wherein the initially liquid composition is applied to a wood substrate with the solvent blend subsequently being allowed to flash away, leaving a substantially solvent free micro-crystalline wax residue barrier on the wood substrate.

15. The composition of claim 14, wherein the organic solvent blend is a blend of hexane and xylene.

16. The composition of claim 15, wherein the organic solvent blend is approximately 83.25% hexane, 3% xylene, 10% micro-crystalline wax and 3.75% commercial stain.

17. The composition of claim 14, wherein the preferred micro-crystalline wax has a weight of about 570-750 g/mole.
